(19) United States
(12) Patent Application Publication
(10) Pub. No.: US 2026/0200280 A1
(43) Pub. Date: Jul. 16, 2026

(54) VEHICLE ADJUSTMENT METHOD AND VEHICLE ADJUSTMENT DEVICE

(71) Applicant: REALTEK SEMICONDUCTOR CORPORATION, HSINCHU (TW)

(72) Inventor: KAI-HSIANG CHOU, Hsinchu (TW)

(21) Appl. No.: 19/444,260

(22) Filed: Jan. 9, 2026

(30) Foreign Application Priority Data
Jan. 14, 2025 (TW) 114101553

(51) Int. Cl. B60G 17/018

(52) U.S. Cl. CPC B60G 17/018; B60G 2400/50; B60G 2400/82; B60G 2500/30; B60G 2800/01

(57) ABSTRACT

A vehicle adjustment method executed by a processor reading at least command stored in a memory is disclosed herein. The vehicle adjustment method includes: determining whether at least one object under a vehicle is a living being; if the at least one object under the vehicle is not the living being, decreasing a height of the vehicle; and if the at least one object under the vehicle is the living being, and a pressure applied to the at least one object by the vehicle is smaller than a predetermined pressure, increasing the height of the vehicle.

### BACKGROUND OF THE INVENTION

### Field of the Invention

The present disclosure relates to a vehicle adjustment method and a vehicle adjustment device, especially to a vehicle adjustment method and a vehicle adjustment device configured to adjust a height of a vehicle for reducing casualties during a traffic accident.

### Description of Related Art

With the advancement of society, people’s awareness of traffic safety has been increasingly enhanced. According to the statistics of the Ministry of Transportation, the total number of traffic accidents each year reaches several hundred thousand, and the casualties of each traffic accident may result in a tragedy for one or more families. Therefore, how to minimize casualties when a traffic accident occurs has become an issue that the industry is committed to studying.

### SUMMARY OF THE INVENTION

In some aspects, an object of the present disclosure is to, but not limited to, provides a vehicle adjustment method and a vehicle adjustment device that makes an improvement to the prior art.

An embodiment of a vehicle adjustment method, executed by a processor reading at least command stored in a memory, includes: determining whether at least one object under a vehicle is a living being; if the at least one object under the vehicle is not the living being, decreasing a height of the vehicle; and if the at least one object under the vehicle is the living being, and a pressure applied to the at least one object by the vehicle is smaller than a predetermined pressure, increasing the height of the vehicle.

An embodiment of a vehicle adjustment device includes a memory and a processor. The memory is configured to store at least one command. The processor is configured to read the at least one command from the memory to perform: determining whether at least one object under a vehicle is a living being; if the at least one object under the vehicle is not the living being, decreasing a height of the vehicle; and if the at least one object under the vehicle is the living being, and a pressure applied to the at least one object by the vehicle is smaller than a predetermined pressure, increasing the height of the vehicle.

Technical features of some embodiments of the present disclosure make an improvement to the prior art. The vehicle adjustment method and the vehicle adjustment device of the present disclosure are configured to adjust a height of a vehicle for reducing casualties during a traffic accident.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a vehicle adjustment device of the present disclosure.

FIG. 2 shows an embodiment of a flow diagram of a vehicle adjustment method of the present disclosure.

FIG. 3 shows an embodiment of a vehicle of the present disclosure.

FIG. 4 shows an embodiment of a relationship between a vehicle and an object of the present disclosure.

FIG. 5 shows an embodiment of a relationship between a vehicle and an object of the present disclosure.

FIG. 6 shows an embodiment of a relationship between a vehicle and an object of the present disclosure.

### DETAILED DESCRIPTION OF THE PREFERRED EMBODIMENTS

To reduce casualties as much as possible during a traffic accident, the present disclosure provides a vehicle adjustment method and a vehicle adjustment device, as detailed below.

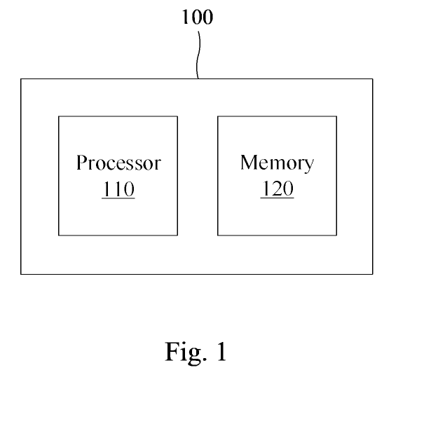

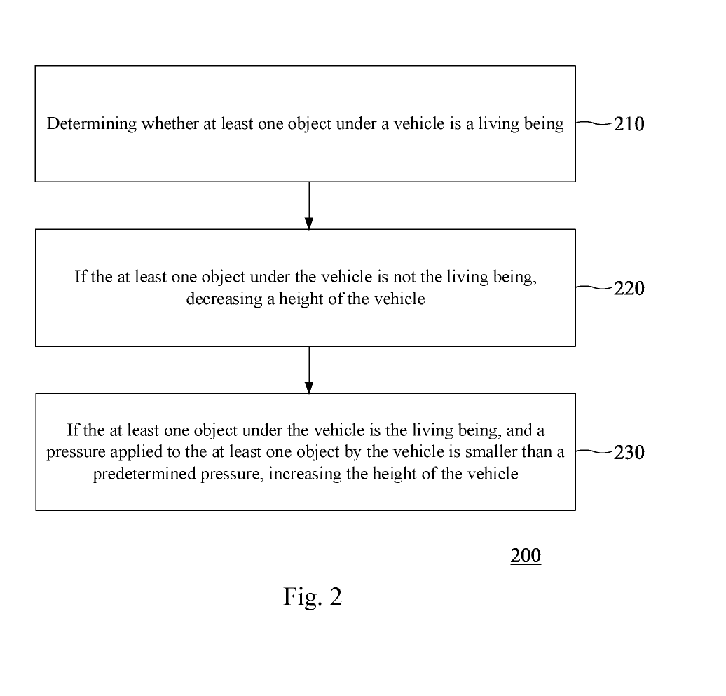

FIG. 1 shows an embodiment of a vehicle adjustment device 100 of the present disclosure. As shown in the figure, the vehicle adjustment device 100 includes a processor 110 and a memory 120. The memory 120 is configured to store at least one command. The processor 110 is configured to read the at least one command to perform a vehicle adjustment process. To facilitate understanding of the operation of the vehicle adjustment device 100, please also refer to FIG. 2. FIG. 2 shows an embodiment of a flow diagram of a vehicle adjustment method 200 of the present disclosure.

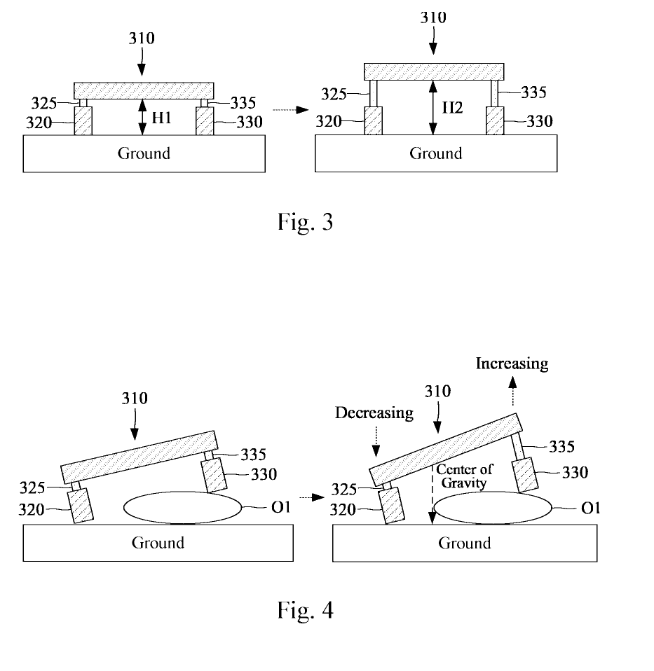

Referring to step 210 in FIG. 2, determining whether at least one object under a vehicle is a living being. For example, to illustrate the basic height adjustment mechanism of the present disclosure, please refer to FIG. 3. A vehicle 310 includes wheels 320, 330, and height adjusters 325, 335. The vehicle 310 can adjust a height H1 on the left side to a height H2 on the right side by the height adjusters 325, 335. Furthermore, referring to FIG. 4, the vehicle adjustment method 200 of the present disclosure can determine whether the object under the vehicle 310 is a living being. It should be noted that the object under the vehicle 310 may include the ground and the object O1. In some embodiments, the height adjusters 325, 335 may be suspension systems, and the height adjustment may range from 5 cm to 10 cm. However, the present disclosure is not limited to this embodiment. In other embodiments, the height adjusters 325, 335 may adopt other suitable components, and the height adjustment may range from 1 cm to 15 cm or other appropriate height adjustment intervals, depending on actual requirements.

Referring to step 220 in FIG. 2, if the at least one object under the vehicle is not the living being, decreasing a height of the vehicle. For example, referring to FIG. 4, the object under the wheel 320 of the vehicle 310 is the ground. Therefore, the object under the wheel 320 of the vehicle 310 is not a living being. The vehicle adjustment method 200 of the present disclosure can, as shown in FIG. 4, decrease a left-side height corresponding to the wheel 320 of the vehicle 310. Specifically, the vehicle 310 utilizes the height adjuster 325 to decrease the left-side height corresponding to the wheel 320.

Referring to step 230 in FIG. 2, if the at least one object under the vehicle is the living being, and a pressure applied to the at least one object by the vehicle is smaller than a predetermined pressure, increasing the height of the vehicle. For example, referring to FIG. 4, if the object O1 under the wheel 330 of the vehicle 310 is a living being, the vehicle adjustment method 200 of the present disclosure can, as shown in FIG. 4, increase a right-side height corresponding to the wheel 330 of the vehicle 310 to shift the center of gravity, and reduce the weight applied to the object O1 by the vehicle 310. In addition, increasing the right-side height corresponding to the wheel 330 of the vehicle 310 can also enlarge a survival space of the object O1. However, before increasing the right-side height of the vehicle 310, it is necessary to determine whether increasing the right-side height of the vehicle 310 will generate a pressure (e.g., a reaction force) on the object O1 to avoid injuring the object O1.

If, after being calculated by the processor 110 shown in FIG. 1, the pressure applied to the object O1 by increasing the right-side height of the vehicle 310 is smaller than the predetermined pressure, it indicates that increasing the right-side height of the vehicle 310 has a relatively small impact on the object O1, and will not injure the object O1. At this time, the vehicle adjustment method 200 of the present disclosure increases the right-side height of the vehicle 310. Specifically, the vehicle 310 utilizes the height adjuster 335 to increase the right-side height corresponding to the wheel 330. Conversely, if, after being calculated by the processor 110 shown in FIG. 1, the pressure applied to the object O1 by increasing the right-side height of the vehicle 310 is greater than or equal to the predetermined pressure, it indicates that increasing the right-side height of the vehicle 310 will have a relatively large impact on the object O1, and may injure the object O1. At this time, the vehicle adjustment method 200 of the present disclosure does not adjust the right-side height of the vehicle 310 to avoid injuring the object O1. In some embodiments, the predetermined pressure may be 5 kilograms. However, the present disclosure is not limited to this embodiment. In other embodiments, the predetermined pressure may be 10 kilograms, 15 kilograms, or other appropriate pressure values, depending on actual requirements.

In some embodiments, please also refer to step 220 in FIG. 2. If at least one object under the vehicle is not a living being, disengaging a wheel of the vehicle to decrease a height of the vehicle. For example, referring to FIG. 4, the object under the wheel 320 of the vehicle 310 is the ground. Therefore, the object under the wheel 320 of the vehicle 310 is not a living being. The vehicle adjustment method 200 of the present disclosure can disengage the wheel 320 of the vehicle 310 to further decrease the left-side height of the vehicle 310.

In some embodiments, the vehicle adjustment method 200 of the present disclosure further includes: calculating a plurality of wheel pressures applied to at least one object by a wheel of a vehicle while the wheel rotates through a plurality of wheel angles; and rotating the wheel of the vehicle to a target wheel angle among the plurality of wheel angles corresponding to a minimum wheel pressure among the plurality of wheel pressures. For example, referring to FIG. 4, the vehicle adjustment method 200 of the present disclosure may calculate 360 wheel pressures applied to an object O1 by a wheel 330 of a vehicle 310 while the wheel 330 rotates through 360 degrees. Assuming that the wheel pressure applied to the object O1 by the wheel 330 is minimum when the wheel 330 rotates to 180 degrees, the vehicle adjustment method 200 of the present disclosure may rotate the wheel 330 of the vehicle 310 to 180 degrees corresponding to the minimum wheel pressure as the target wheel angle. In this way, the vehicle adjustment method 200 of the present disclosure can further reduce the pressure on the object O1.

In some embodiments, please also refer to step 210 in FIG. 2. The vehicle adjustment method 200 of the present disclosure is further configured to determine whether a first object under a first wheel of a vehicle is a living being; and determine whether a second object under a second wheel of the vehicle is a living being. For example, referring to FIG. 5, the vehicle adjustment method 200 of the present disclosure is further configured to determine whether an object O1 under a wheel 320 of a vehicle 310 is a living being; and determine whether an object O4 under a wheel 330 of the vehicle 310 is a living being. If the object O1 under the wheel 320 of the vehicle 310 is a living being, and a pressure applied to the object O1 by the wheel 320 of the vehicle 310 is smaller than a predetermined pressure, the vehicle adjustment method 200 of the present disclosure increases a left-side height corresponding to the wheel 320 of the vehicle 310. If the object O4 under the wheel 330 of the vehicle 310 is not a living being, the vehicle adjustment method 200 of the present disclosure decreases a right-side height corresponding to the wheel 330 of the vehicle 310. As shown in the figure, after the height of the vehicle 310 is adjusted by the vehicle adjustment method 200 of the present disclosure, a center of gravity of the vehicle 310 shifts toward the object O4 (e.g., the non-living being). In this way, the vehicle adjustment method 200 of the present disclosure can reduce the weight applied by the vehicle 310 to the object O1 (e.g., the living being). In addition, increasing the left-side height corresponding to the wheel 320 of the vehicle 310 can also increase a survival space of the object O1 (e.g., the living being).

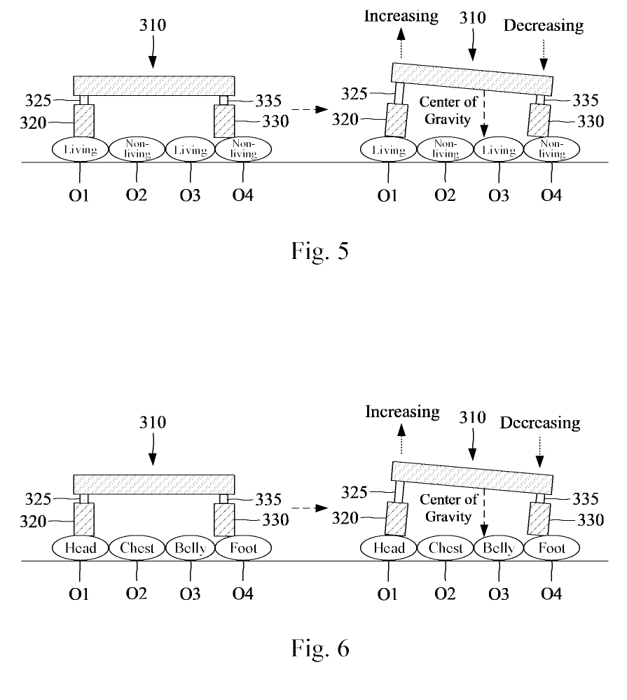

In some embodiments, please also refer to step 210 in FIG. 2. The vehicle adjustment method 200 of the present disclosure is further configured to determine whether a first object under a first wheel of a vehicle is a living being; and determine whether a second object under a second wheel of the vehicle is a living being. For example, referring to FIG. 6, the vehicle adjustment method 200 of the present disclosure is further configured to determine whether an object O1 under a wheel 320 of a vehicle 310 is a living being; and determine whether an object O4 under a wheel 330 of the vehicle 310 is a living being. If the object O1 under the wheel 320 of the vehicle 310 is a living being, and the object O4 under the wheel 330 of the vehicle 310 is a living being, for example, where the object O1 is a head of a human body and the object O4 is a Chest of the human body, since the height adjustment of the vehicle 310 will affect both the object O1 and the object O4, the vehicle adjustment method 200 of the present disclosure needs to compare a weight of the object O1 and a weight of the object O4.

If the weight of the object O4 is smaller than the weight of the object O1, it indicates that the importance of the object O4 is lower than that of the object O1. At this time, the vehicle adjustment method 200 of the present disclosure decreases a right-side height corresponding to the wheel 330 of the vehicle 310. In addition, for the object O1 with higher importance, before increasing the left-side height of the vehicle 310, it is necessary to determine a pressure applied to the object O1 by increasing the left-side height of the vehicle 310 to avoid further injuring the object O1. If a pressure applied to the object O1 by the wheel 320 of the vehicle 310 is smaller than the predetermined pressure, it indicates that increasing the left-side height of the vehicle 310 has a smaller impact on the object O1, and will not injure the object O1. At this time, the vehicle adjustment method 200 of the present disclosure may increase the left-side height corresponding to the wheel 320 of the vehicle 310. As shown in the figure, after the height of the vehicle 310 is adjusted by the vehicle adjustment method 200 of the present disclosure, a center of gravity of the vehicle 310 shifts toward the object O4 (e.g., the less important foot). In this way, the vehicle adjustment method 200 of the present disclosure can reduce the weight applied by the vehicle 310 to the object O1 (e.g., the more important head). In addition, increasing the left-side height corresponding to the wheel 320 of the vehicle 310 can also increase a survival space of the object O1 (e.g., the more important head).

In some embodiments, referring to FIG. 6, if the weight of the object O4 is smaller than the weight of the object O1, as described above, the vehicle adjustment method 200 of the present disclosure may decrease the right-side height corresponding to the wheel 330 of the vehicle 310. However, before decreasing the right-side height corresponding to the wheel 330 of the vehicle 310, it may first determine a pressure applied to the object O4 by decreasing the right-side height of the vehicle 310 to avoid further injuring the object O4. If, after being calculated by the processor 110 shown in FIG. 1, a pressure applied to the object O4 by decreasing the right-side height of the vehicle 310 is smaller than a predetermined pressure, it indicates that decreasing the right-side height of the vehicle 310 has a relatively small impact on the object O4, and will not injure the object O4. At this time, the vehicle adjustment method 200 of the present disclosure decreases the right-side height corresponding to the wheel 330 of the vehicle 310. Conversely, if, after being calculated by the processor 110 shown in FIG. 1, a pressure applied to the object O4 by decreasing the right-side height of the vehicle 310 is greater than or equal to the predetermined pressure, it indicates that decreasing the right-side height of the vehicle 310 has a relatively large impact on the object O4, and may injure the object O4. At this time, the vehicle adjustment method 200 of the present disclosure does not adjust the right-side height of the vehicle 310.

In some embodiments, the present disclosure can set a weight of an object according to the importance of the object. For example, the present disclosure can assign a higher weight to an object of higher importance, and assign a lower weight to an object of lower importance. Assuming that the maximum weight value is 10, an object O1 (e.g., a head) shown in FIG. 6 can be set to 10, an object O2 (e.g., a chest) can be set to 7, an object O3 (e.g., a belly) can be set to 4, and an object O4 (e.g., a foot) can be set to 1. However, the present disclosure is not limited to this embodiment. In other embodiments, the weight of the object can be set to other appropriate weight values depending on actual requirements.

In some embodiments, an adjustment time for decreasing the height of the vehicle 310 or increasing the height of the vehicle 310 in the vehicle adjustment method 200 of the present disclosure is greater than a predetermined time. For example, an adjustment time for decreasing the height of the vehicle 310 in the vehicle adjustment method 200 of the present disclosure may be greater than one minute. In this way, since the vehicle adjustment method 200 of the present disclosure slowly decreases the height of the vehicle 310, the damage to the object is relatively small. On the other hand, an adjustment time for increasing the height of the vehicle 310 in the vehicle adjustment method 200 of the present disclosure may also be greater than one minute. In this way, since the vehicle adjustment method 200 of the present disclosure slowly increases the height of the vehicle 310, the damage to the object is relatively small. However, the present disclosure is not limited to this embodiment. In other embodiments, the predetermined time may be 30 seconds, 2 minutes, or other suitable time values depending on actual requirements.

In some embodiments, the present disclosure can detect a type of living being outside (e.g., under) the vehicle 310 through a YOLO (You Only Look Once) object detection technique. In addition, the present disclosure can also determine whether a type of living being outside (e.g., under) the vehicle 310 is a human through a radio frequency identification (RFID) technology, a pacemaker, or a smart wearable device. Furthermore, the present disclosure can also determine whether a type of living being outside (e.g., under) the vehicle 310 is a pet through an implanted chip.

In some embodiments, the present disclosure can perform a 2D analysis on an object by an artificial intelligence (AI) model through object detection, or further determine whether an occluded object is pressed by the vehicle 310 through skeleton detection by the AI model.

In some embodiments, if there is no living being outside (e.g., under) the vehicle 310, the present disclosure can also detect objects inside the vehicle 310, such as detecting passengers and loaded cargo inside the vehicle 310. For example, if a passenger A presses a passenger B, the present disclosure can also reduce a pressure on the passenger B by adjusting a height of the vehicle 310. In addition, if cargo presses the passenger B, the present disclosure can also reduce a pressure on the passenger B by adjusting a height of the vehicle 310.

In some embodiments, the pressure may be a pressure applied to an object by the vehicle 310, and the present disclosure can calculate the pressure through sensors of the wheels 320, 330 of the vehicle 310. In addition, if a tree presses the vehicle 310, the present disclosure can also calculate the pressure through the sensors of the wheels 320, 330 of the vehicle 310. Furthermore, the pressure may also be a pressure applied to an object by another vehicle. For example, if a left hand of a motorcyclist is pressed by a motorcycle, and the motorcycle is pressed by a car, the present disclosure can calculate the pressure through an AI model. In some embodiments, before performing the vehicle adjustment method 200 of the present disclosure, passengers inside the vehicle 310 may first exit the vehicle 310 to preliminarily reduce a pressure applied to an object outside the vehicle 310 by the vehicle 310.

It should be noted that the present disclosure is not limited to the embodiments as shown in FIG. 1 to FIG. 6, they are merely examples for illustrating the implements of the present disclosure, and the scope of the present disclosure shall be defined based on the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

Technical features of some embodiments of the present disclosure make an improvement to the prior art. The vehicle adjustment method and the vehicle adjustment device of the present disclosure are configured to adjust a height of a vehicle for reducing casualties during a traffic accident.

It should be noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A vehicle adjustment method, executed by a processor reading at least command stored in a memory, comprising:
determining whether at least one object under a vehicle is a living being;
if the at least one object under the vehicle is not the living being, decreasing a height of the vehicle; and
if the at least one object under the vehicle is the living being, and a pressure applied to the at least one object by the vehicle is smaller than a predetermined pressure, increasing the height of the vehicle.

2. The vehicle adjustment method of claim 1, further comprising:
if the at least one object under the vehicle is the living being, and the pressure applied to the at least one object by the vehicle is greater than or equal to the predetermined pressure, not adjusting the height of the vehicle.

3. The vehicle adjustment method of claim 1, whether if the at least one object under the vehicle is not the living being, decreasing the height of the vehicle comprises:
if the at least one object under the vehicle is not the living being, disengaging a wheel of the vehicle to decrease the height of the vehicle.

4. The vehicle adjustment method of claim 1, further comprising:
calculating a plurality of wheel pressures applied to the at least one object by a wheel of the vehicle while the wheel rotates through a plurality of wheel angles; and
rotating the wheel of the vehicle to a target wheel angle among the plurality of wheel angles corresponding to a minimum wheel pressure among the plurality of wheel pressures.

5. The vehicle adjustment method of claim 1, wherein the vehicle comprises a first wheel and a second wheel, and wherein determining whether the at least one object under the vehicle is the living being comprises:
determining whether a first object under the first wheel of the vehicle is the living being; and
determining whether a second object under the second wheel of the vehicle is the living being.

6. The vehicle adjustment method of claim 5, further comprising:
if the first object under the first wheel of the vehicle is the living being, and the pressure applied to the first object by the first wheel of the vehicle is smaller than the predetermined pressure, increasing a first height corresponding to the first wheel of the vehicle; and
if the second object under the second wheel of the vehicle is not the living being, decreasing a second height corresponding to the second wheel of the vehicle.

7. The vehicle adjustment method of claim 5, further comprising:
if the first object under the first wheel of the vehicle is the living being, and the second object under the second wheel of the vehicle is the living being, comparing a first weight of the first object and a second weight of the second object;
if the first weight of the first object is smaller than the second weight of the second object, decreasing a first height corresponding to the first wheel of the vehicle; and
if the pressure applied to the second object by the second wheel of the vehicle is smaller than the predetermined pressure, increasing a second height corresponding to the second wheel of the vehicle.

8. The vehicle adjustment method of claim 7, wherein if the first weight of the first object is smaller than the second weight of the second object, decreasing the first height of the first wheel of the vehicle comprises:
if the first weight of the first object is smaller than the second weight of the second object, and the pressure applied to the first object by the first wheel of the vehicle is smaller than the predetermined pressure, decreasing the first height corresponding to the first wheel of the vehicle.

9. The vehicle adjustment method of claim 8, wherein if the first weight of the first object is smaller than the second weight of the second object, decreasing the first height of the first wheel of the vehicle comprises:
if the first weight of the first object is smaller than the second weight of the second object, and the pressure applied to the first object by the first wheel of the vehicle is greater than or equal to the predetermined pressure, not adjusting the first height corresponding to the first wheel of the vehicle.

10. The vehicle adjustment method of claim 1, wherein an adjust time for decreasing the height of the vehicle or increasing the height of the vehicle is greater than a predetermined time.

11. A vehicle adjustment device, comprising:
a memory, configured to store at least one command; and
a processor, configured to read the at least one command from the memory to perform:
determining whether at least one object under a vehicle is a living being;
if the at least one object under the vehicle is not the living being, decreasing a height of the vehicle; and
if the at least one object under the vehicle is the living being, and a pressure applied to the at least one object by the vehicle is smaller than a predetermined pressure, increasing the height of the vehicle.

12. The vehicle adjustment device of claim 11, wherein the processor is further configured to read the at least one command from the memory to perform:
if the at least one object under the vehicle is the living being, and the pressure applied to the at least one object by the vehicle is greater than or equal to the predetermined pressure, not adjusting the height of the vehicle.

13. The vehicle adjustment device of claim 11, wherein the processor is further configured to read the at least one command from the memory to perform:
if the at least one object under the vehicle is not the living being, disengaging a wheel of the vehicle to decrease the height of the vehicle.

14. The vehicle adjustment device of claim 11, wherein the processor is further configured to read the at least one command from the memory to perform:
calculating a plurality of wheel pressures applied to the at least one object by a wheel of the vehicle while the wheel rotates through a plurality of wheel angles; and
rotating the wheel of the vehicle to a target wheel angle among the plurality of wheel angles corresponding to a minimum wheel pressure among the plurality of wheel pressures.

15. The vehicle adjustment device of claim 11, whether the vehicle comprises a first wheel and a second wheel, whether the processor is further configured to read the at least one command from the memory to perform:
determining whether a first object under the first wheel of the vehicle is the living being; and
determining whether a second object under the second wheel of the vehicle is the living being.

16. The vehicle adjustment device of claim 15, wherein the processor is further configured to read the at least one command from the memory to perform:
if the first object under the first wheel of the vehicle is the living being, and the pressure applied to the first object by the first wheel of the vehicle is smaller than the predetermined pressure, increasing a first height corresponding to the first wheel of the vehicle; and
if the second object under the second wheel of the vehicle is not the living being, decreasing a second height corresponding to the second wheel of the vehicle.

17. The vehicle adjustment device of claim 15, wherein the processor is further configured to read the at least one command from the memory to perform:
if the first object under the first wheel of the vehicle is the living being, and the second object under the second wheel of the vehicle is the living being, comparing a first weight of the first object and a second weight of the second object;
if the first weight of the first object is smaller than the second weight of the second object, decreasing a first height corresponding to the first wheel of the vehicle; and
if the pressure applied to the second object by the second wheel of the vehicle is smaller than the predetermined pressure, increasing a second height corresponding to the second wheel of the vehicle.

18. The vehicle adjustment device of claim 17, wherein the processor is further configured to read the at least one command from the memory to perform:
if the first weight of the first object is smaller than the second weight of the second object, and the pressure applied to the first object by the first wheel of the vehicle is smaller than the predetermined pressure, decreasing the first height corresponding to the first wheel of the vehicle.

19. The vehicle adjustment device of claim 18, wherein the processor is further configured to read the at least one command from the memory to perform:
if the first weight of the first object is smaller than the second weight of the second object, and the pressure applied to the first object by the first wheel of the vehicle is greater than or equal to the predetermined pressure, not adjusting the first height corresponding to the first wheel of the vehicle.

20. The vehicle adjustment device of claim 11, wherein an adjust time for decreasing the height of the vehicle or increasing the height of the vehicle is greater than a predetermined time.
